(19) United States
(12) Patent Application Publication
(10) Pub. No.: US 2023/0341744 A1
(43) Pub. Date: Oct. 26, 2023

(54) CLUSTER QUANTUM STATE GENERATION BASED ON PHASE MODULATED OPTICAL PARAMETRIC OSCILLATOR

(71) Applicants: University of Virginia Patent Foundation, Charlottesville, VA (US); Bar-Ilan University, Ramat Gan (IL)

(72) Inventors: Olivier Pfister, Charlottesville, VA (US); Carlos Gonzalez-Arciniegas, Charlottesville, VA (US); Xuan Zhu, Charlottesville, VA (US); Chun-Hung Chang, Charlottesville, VA (US); Avi Pe'er, Nes Ziona (IL)

(73) Assignees: University of Virginia Patent Foundation, Charlottesville, VA (US); Bar-Ilan University, Ramat Gan (IL)

(21) Appl. No.: 18/025,878

(22) PCT Filed: Sep. 8, 2021
(86) PCT No.: PCT/US2021/049505

§ 371 Date: Mar. 10, 2023

Related U.S. Application Data
(60) Provisional application No. 63/077,024, filed on Sep. 11, 2020.

(51) Int. Cl. G02F 1/39; G02F 1/35; G06N 10/40

(52) U.S. Cl. CPC G02F 1/39; G02F 1/3546; G02F 1/3507; G06N 10/40

(57) ABSTRACT

Systems and methods are disclosed for generating cluster quantum states usable for quantum computing. An example system can generate a plurality of qumodes. The plurality of qumodes can include at least two successive qumodes in frequency domain, wherein a frequency spacing between two successive qumodes is equal to a free-spectral range of an optical frequency comb. The plurality of qumodes can include a plurality of bipartite entangled states. A cluster quantum state can be generated by modulating a phase of a portion of the optical fields associated with the plurality of qumodes received from the optical frequency comb, at one or more modulation frequencies. In some embodiments, each of the one or more modulation frequencies can be equal to an integral multiple of the free-spectral-range. In certain embodiments, a property of a cluster graph (such as a dimension of the cluster graph) associated with the cluster quantum state can be controlled by adjusting one or more modulation frequencies.

### CROSS-REFERENCE TO RELATED APPLICATION

This application claims priority to U.S. Provisional Patent Application No. 63/077,024, filed Sep. 11, 2020, titled “System and method for phase modulated optical parametric oscillator as a quantum computing platform,” the entire contents of which are incorporated by reference herein and made part of this specification.

### STATEMENT REGARDING FEDERALLY SPONSORED RESEARCH OR DEVELOPMENT

This invention was made with Government support under Contract Nos. PHY-1820882, DMR-1839175, and EECS-1842641, awarded by the National Science Foundation. The Government has certain rights in this invention.

### BACKGROUND

### Technical Field

This disclosure relates to generation of cluster quantum states for quantum computing. In particular, the devices and methods described herein may be used to generate cluster quantum states that are usable for continuous-variable quantum computing.

### Description of Related Art

Quantum computing (QC) is a new approach to computing that exploits the quantum nature of fields and particles to provide improvement in calculations required to solve particular mathematical problems. Quantum computing may exponentially increase the computation speed compared to classical computing and enable solving computationally complex problems, such as simulating many-body quantum systems, using resources and within timeframes suitable for practical applications.

A conventional approach to QC is based on discrete units of quantum information known as quantum bits or qubits and uses the quantum behavior of discrete parameters associated with physical entities (e.g., electrons, photons, atoms, etc.) to implement the corresponding quantum computing algorithms. Implementing QC based on conventional approach requires precise control of each single qubit and the interaction between qubits while maintaining the coherence of the corresponding quantum states. As such, conventional QC systems are difficult to build, maintain and control. More importantly, because of these problems (i.e., decoherence and difficulty of precise control), scalability of conventional QC systems is a major challenge that limits the computation speed in these systems.

### SUMMARY

The systems, methods and devices of this disclosure each have several innovative aspects, no single one of which is solely responsible for all of the desirable attributes disclosed herein. Some implementations are summarized in this section, and other implementations are disclosed elsewhere in this specification. Details of one or more implementations of the subject matter described in this specification are set forth in the accompanying drawings and the description below.

Certain embodiments disclosed herein provide a scalable method for generating a continuous-variable (CV) cluster quantum state (cluster state) using a single source of independent entangled quantum states (e.g., bipartite entangled states) and a single-step clustering process that entangles the independent entangled quantum states. In some embodiments, the single step clustering process may simultaneously entangle all the independent entangled quantum states to form the cluster state.

In some embodiments, the method comprises generating independent entangled states using the single source, and clustering them, after they are output by the single source, using a clustering device. In some examples, the bipartite entangled states can be two-qumode entangled states generated by a source of two-qumode entangled states. The method may comprise transmitting the two-qumode entangled states to the clustering device configured to generate the CV quantum cluster states by entangling (e.g., simultaneously entangled) the two-qumode entangled states. The method further comprises controlling the clustering process to tailor certain properties of the resulting cluster state (e.g., dimension, size and topology of a corresponding graph) by manipulating the clustering process. In some examples, the clustering process may be manipulated independent of the source of independent qubits or qumodes. Some embodiments may generate hypercubic cluster states. The method may be used to generate and control large and complex CV cluster states for universal quantum computation.

Certain embodiments disclosed herein provide a scalable method for generating a continuous-variable (CV) cluster quantum state (cluster state) in a single device by combining a process for generating independent entangled quantum states (e.g., bipartite entangled states) and the clustering process for entangling the independent entangled states. The clustering process may comprise entangling each state of an independent entangled state with one or more other states each belonging to a different independent entangled state. In some cases, the two processes may be concurrent. In some cases, the cluster state may be generated via periodic repetition of entangled state generation and clustering within a single device (e.g., within a resonant optical cavity). The method may comprise controlling the clustering process to tailor certain properties of the resulting cluster state (e.g., dimension, size and topology of a corresponding graph) by manipulating the clustering process. The method may be used to generate and control large and complex CV cluster states for universal quantum computation.

Certain embodiments disclosed herein provide a scalable method for generating a continuous-variable (CV) cluster quantum state (cluster state) based on a single source of independent non-classical states. The method comprises generating independent non-classical states (e.g., squeezed states) using a single source and simultaneously entangling the independent non-classical states. In some cases, each independent non-classical state may be entangled with two other independent non-classical states. In some cases, the cluster state may be generated by simultaneous generation and entanglement of the non-classical states. In some examples, the clustering process may be manipulated independent of the source of independent entangled states. Some embodiments may generate hypercubic cluster states. The method may be used to generate and control large and complex CV cluster states for universal quantum computation. The method further comprises controlling the clustering process to tailor the properties of the resulting cluster state (e.g., dimension, size and topology of a corresponding graph) by manipulating the clustering process.

Certain embodiments provide an apparatus for generating a CV cluster quantum state comprising qumodes. The apparatus may comprise an optical frequency comb (OFC) generator configured to generate an OFC comprising a plurality of optical field components oscillating at a plurality of equally spaced frequency components wherein each optical field component constitutes a qumode. The frequency spacing between two consecutive frequency components may be substantially equal to a free-spectral-range of an optical cavity of the OFC generator. The plurality of optical field components may comprise a plurality of two-qumode entangled states. The apparatus may further comprise an optical phase modulator configured to receive the OFC from the OFC generator and modulate an optical phase of each qumode of the plurality of two-qumode entangled states at one or more modulation frequencies. The CV cluster quantum state may be generated by selecting one or more modulation frequencies to be substantially equal to an integral multiple the free-spectral-range.

Certain embodiments provide an apparatus for generating a CV cluster quantum state comprising entangled optical fields. The apparatus may comprise an optical cavity and a nonlinear optical medium configured to generate and sustain an OFC comprising a plurality of optical field components oscillating at a plurality of equally spaced frequency components wherein each optical field component constitutes a qumode. The frequency spacing between two consecutive frequency components may be substantially equal to a free-spectral-range of the optical cavity. The plurality of optical field components may comprise a plurality of two-qumode entangled states. The apparatus may further comprise an optical phase modulator placed inside the optical cavity and configured to modulate an optical phase of each qumode of a plurality of two-qumode entangled states at one or more modulation frequencies. In some embodiments, the nonlinear optical medium may be further configured to modulate the optical phase of each qumode of a plurality of two-qumode entangled states at one or more modulation frequencies. In some such embodiments, the cluster state may be generated without the need for optical phase modulator. The CV cluster quantum state may be generated by selecting one or more modulation frequencies to be substantially equal to an integral multiple the free-spectral-range.

Some embodiments provide an apparatus for generating a cluster quantum state using bipartite entangled states. The apparatus can include an optical parametric oscillator (OPO) configured to generate a plurality of two-qumode entangled states. The OPO can include an optical cavity having a free-spectral-range and configured to sustain a plurality of qumodes, a first nonlinear optical medium located inside the optical cavity and configured to interact with the plurality of qumodes, and an optical source configured to generate a pump wave having a pump frequency ωₚ) and transmit the pump wave into the first nonlinear optical medium to generate the plurality of qumodes via a first nonlinear optical interaction of the pump wave with the first nonlinear optical medium. The plurality of qumodes can include at least two successive qumodes in frequency domain. A frequency spacing between the two successive qumodes can be equal to the free-spectral range. The plurality of qumodes can include the plurality of two-qumode entangled states. The OPO can include an OPO output port configured to transmit a portion of optical fields associated with the plurality qumodes out of the optical cavity. The apparatus can include an optical phase modulator configured to generate the cluster quantum state by modulating a phase of the portion of the optical fields associated with the plurality of qumodes transmitted from the OPO output port at one or more modulation frequencies and with a modulation index. The one or more modulation frequencies can be integral multiples of the free-spectral-range.

In some embodiments, the cluster quantum state is generated by simultaneously entangling at least a portion of the plurality of qumodes via optical phase modulation.

In certain embodiments, the optical phase modulator includes an input optical port configured to receive the portion of the optical fields associated with the plurality of qumodes, a second nonlinear optical medium configured to interact with the portion of the optical fields received from the input optical port, one or more RF ports configured to receive one or more RF signals and generate RF fields inside the second nonlinear optical medium to modulate the phase of the optical fields via a second nonlinear optical interaction, and an optical output port configured to transmit output optical fields comprising the cluster quantum state. The apparatus for generating a cluster quantum state can include one or more RF sources configured to generate the one or more RF signals, wherein the one or more RF signals have one or more RF frequencies, and wherein each RF frequency is equal to the one or more modulation frequencies.

In some embodiments, the optical phase modulator includes an input optical port configured to receive the portion of the optical fields associated with the plurality of qumodes, a second nonlinear optical medium configured to interact with the portion of the optical fields received from the input optical port, and one or more optical modulation ports configured to receive one or more optical modulating signals wherein the one or more modulating optical signals are configured to modulate the phase of the optical fields at one or more modulation frequencies via a second nonlinear optical interaction between the optical fields and the one or more optical signals inside the second nonlinear medium.

In certain embodiments, an apparatus for generating a cluster quantum state includes one or more optical sources configured to generate the one or more optical signals. In some embodiments, the plurality of qumodes comprise a plurality of resonant optical fields inside the optical cavity. The optical phase modulator can generate the cluster quantum state by entangling at least one qumode in at least one two-qumode entangled state to a number of qumodes in other two-qumode entangled states. The number of qumodes in other two-qumode entangled states can be determined by the modulation index. The modulation index can be sufficiently small so that the optical phase modulator entangles a qumode with two qumodes. The plurality of qumodes can include a plurality of non-classical optical fields. The plurality of non-classical optical fields can include squeezed states. At least some of the plurality of two-qumode entangled states can include a two-squeezed Einstein-Podolski-Rosen (EPR) pair. In some embodiments, the modulation index is greater than 0 and less than 1. A dimension of the cluster quantum state can be equal to a number of modulation frequencies. A size of the cluster quantum state can be equal to a number of qumodes.

In some embodiments, the first nonlinear optical interaction is a second order nonlinear optical interaction. A difference between ωₚ/2 and a qumode frequency can be zero or half of the free spectral range. The pump frequency ωₚ or half of the pump frequency ωₚ/2 may overlap or coincide with a qumode frequency. The first nonlinear optical interaction can also be a third order nonlinear optical interaction. A difference between oil, and a qumode frequency can be zero or half of the free spectral range. The second nonlinear optical interaction can be a second order nonlinear optical interaction. The second nonlinear optical interaction can be a third order nonlinear optical interaction.

In certain embodiments, the OPO is a quantum OPO. The cluster quantum state can be a two-dimensional cluster quantum state or an n-dimensional cluster quantum state, wherein n is an integer number equal to or greater than three.

In some embodiments, the optical modulator is configured to control a property of a cluster graph associated with the cluster quantum state. A number of spokes in the cluster graph can be equal to a ratio between the largest and the second largest of the one or more modulation frequencies. The cluster quantum state can be a 3-dimensional cluster quantum state. A number of two-qumode entangled states along a height of the graph can be equal to a ratio between the second largest modulation frequency and the smallest of the one or more modulation frequencies.

In certain embodiments, the apparatus includes a control and stabilization system configured to control a property of the cluster quantum state at least partially by controlling the one or more RF signals. The apparatus can include a measurement system configured to perform a measurement on the cluster quantum state based on a measurement base. The apparatus can include a computing system configured to execute a quantum algorithm at least partially by selecting the measurement base and controlling the measurement system. The computing system can be configured to generate an output based at least in part on an outcome of the measurement. The computing system can be further configured to control a property of the cluster quantum state. The cluster quantum state can be a continuous variable cluster quantum state.

### BRIEF DESCRIPTION OF THE DRAWINGS

The systems, methods, and devices of this disclosure each have several innovative aspects, no single one of which is solely responsible for all of the desirable attributes disclosed herein. Details of one or more implementations of the subject matter described in this specification are set forth in the accompanying drawings and the description below.

FIG. 1A shows a block diagram of an example system for generating a cluster quantum state.

FIG. 1B shows a block diagram of another example system for generating a cluster quantum state.

FIG. 2A shows a block diagram of an example quantum apparatus for generating a cluster quantum state.

FIG. 2B shows a block diagram of another example quantum apparatus for generating a cluster quantum state.

FIG. 3A illustrates a frequency spectrum of a quantum optical frequency comb (Q-OFC) comprising two-qumode entangled states.

FIG. 3B illustrates a frequency spectrum of a quantum optical frequency comb (Q-OFC) comprising a cluster state generated by modulating the phase of Q-OFC optical field components at a modulation frequency of FSR.

FIG. 3C illustrates a frequency spectrum of a quantum optical frequency comb (Q-OFC) comprising a cluster state generated by modulating the phase of the Q-OFC optical field components at a first modulation frequency of FSR and a second modulation frequency of 2×FSR.

FIG. 4A is a graph representing a square grid cluster state generated by modulating an optical phase of the qumodes of two-qumode entangled states associated with a Q-OFC, at 10×FSR and 20×FSR.

FIG. 4B is a graph representing a cubic cluster state generated by modulating an optical phase of the qumodes of two-qumode entangled states associated with a Q-OFC, at 1×FSR and 8×FSR and 80×FSR.

FIG. 5A shows a block diagram of an example implementation of the quantum apparatus shown in FIG. 2B based on an externally phase-modulated optical parametric oscillator.

FIG. 5B shows a block diagram of an example implementation of the quantum apparatus shown in FIG. 2A based on internally phase-modulated optical parametric oscillator.

FIG. 6 shows a block diagram of an example quantum computing system that uses the quantum apparatus shown in FIG. 5A or FIG. 5B, to generate a CV cluster.

### DETAILED DESCRIPTION

Although certain embodiments and examples are disclosed below, inventive subject matter extends beyond the specifically disclosed embodiments to other alternative embodiments and/or uses and to modifications and equivalents thereof.

Thus, the scope of the claims appended hereto is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order dependent. Additionally, the structures, systems, and/or devices described herein may be embodied using a variety of techniques including techniques that may not be described herein but are known to a person having ordinary skill in the art. For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein. It will be understood that when an element or component is referred to herein as being “connected” or “coupled” to another element, it can be directly connected or coupled to the other element or intervening elements can be present there between.

Any feature, structure, component, material, step, or method that is described and/or illustrated in any embodiment in this specification can be used with or instead of any feature, structure, component, material, step, or method that is described and/or illustrated in any other embodiment in this specification. Additionally, any feature, structure, component, material, step, or method that is described and/or illustrated in one embodiment may be absent from another embodiment.

In various embodiments disclosed herein, an entangled state, a two-qumode entangled state, a cluster state and the like may comprise, one or more fields or one or more particles being in the corresponding state (e.g., quantum state). For example, a two-qumode entangled state may comprise two optical fields that are in an entangled state, and the cluster state may comprise a plurality of optical fields being in a cluster state.

An alternative to the conventional approach to QC that can overcome certain limitations of the conventional discrete variable quantum computing is continuous-variable (CV) quantum computing. In continuous-variable quantum computing (CVQC), quantum information is encoded in continuous quantum variables associated with a physical entity (e.g., an optical field). For example, the quadratures of an optical field (an electromagnetic field oscillating at optical frequencies) can serve as continuous quantum variables. In some cases, optical fields can be generated in the form of quantum modes or “qumodes”. A qumode can be a resonant optical field (e.g., an optical field sustained inside an optical cavity) whose quantum properties may be exploited for quantum computing or quantum information processing (similar to a qubit). In some examples, a qumode can be in a non-classical state. For example, a qumode can be a squeezed optical field or a squeezed resonant optical field.

Because a single optical cavity, such as that of a laser or of an optical parametric oscillator, can sustain a large number of resonant optical frequency modes (e.g., thousands to millions, depending on the optical cavity configuration), qumode-based QC is highly scalable. In particular, such frequency multiplexing allows one to use a single light source (e.g., a source of quantum light), rather than building a large number of identical such sources. Moreover, the use of photons, which are noninteracting bosons, may provide a high degree of immunity to quantum decoherence, for example, by blocking several avenues to decoherence. Quantum decoherence typically results from interaction of qubits or qumodes with their surrounding environment and can be highly detrimental to corresponding QC operations.

One-way QC is a measurement-based quantum computing method based on a cluster quantum state, which is a specific multipartite entangled state. A cluster quantum state can be a discrete variable cluster quantum state generated by entangling a plurality of discrete-variable quantum systems (e.g., a plurality of qubits), or a CV quantum cluster state, herein referred to as a “cluster state”, generated by entangling a plurality of CV quantum systems (e.g., a plurality of qumodes). One-way QC starts with preparing a cluster state and then performing single-qubit or single-qumode measurements on the cluster quantum state. In one-way QC, quantum information is encoded and exists in the cluster state and is manipulated by selecting measurement bases and a sequence of local (single qubit) measurements based on the selected measurement bases, followed by feedforward to neighboring qubits in the cluster state. In one-way QC, a quantum algorithm may be implemented by preparing a cluster state, selecting specific measurement bases, performing the corresponding measurements based on the selected measurement bases, and applying feedforward to the neighbors of the measured sites of the cluster graph. As such, one-way QC consolidates most of the challenging tasks associated with quantum computation into creating a cluster state (also known as an entangled resource state) and controlling the local measurements and feedforward. In addition, some one-way QC schemes allow very high fault-tolerance thresholds and may therefore enable fabrication of more practical QC systems at a lower cost.

A quantum computing system that uses one-way QC is defined by the properties of the cluster quantum state (entangled resource state) used to implement the quantum algorithm. For example, a size or a dimension of the quantum cluster state or the topology of the corresponding graph (the mathematical representation of the cluster state), may limit the type of algorithms than can be implemented. In general, larger cluster quantum states may enable more complex computational tasks or increase the computation speed compared to smaller quantum cluster states. While a two-dimensional cluster quantum state can serve as an entangled resource state for universal quantum computing, cubic and hypercubic cluster quantum states may enable certain quantum computing and quantum information processing tasks that may not be achievable using cluster quantum states with lower dimensions. For example, it has been shown that cubic cluster quantum states may allow quantum error correction topological encoding.

Whereas generating large and high dimensional cluster states based on discrete quantum variables is a very challenging task, this is not the case for CV implementations and CV cluster states are by far the largest cluster states to date.

Some of the existing methods for generating and preparing CV cluster states (cluster states) use one or more quantum sources of independent entangled states (e.g., each entangled state can be a two-qumode entangled state) and by sequentially entangling the independent entangled states until a cluster state with a desired size and properties is obtained. The process of entangling the independent entangled states may include several steps, for example, including entangling two independent entangled states, and then entangling the resulting state with another entangled state. Such clustering processes may be defined as entangling, in a “bottom up” manner, independent qubits or qumodes, qubits or qumodes in independent entangled states.

As such generating a large CV cluster state using the existing methods, still requires large and complex systems comprising optical delays, multiple interferometers and sometime a large number of sources of independent entangled states. Moreover, the components and steps required to entangle the independent entangled states may make the system and therefore the resulting cluster state highly susceptible to noise and decoherence. Controlling these sources and components can be difficult and may require expensive and sometimes large control systems. As such, while controlling the cluster generation process and preparation of cluster quantum states with characteristic tailored for specific tasks is highly desired, existing method may not allow such level of control.

In contrast, certain embodiments disclosed herein provide a scalable method for generating a continuous-variable (CV) cluster quantum state (cluster state) using a single source of independent entangled quantum states (e.g., bipartite entangled states) and a single-step clustering process that entangles the independent entangled quantum states in a “top down” manner. In some embodiments, the single step clustering process may simultaneously entangle all the independent entangled quantum states to form the cluster state.

Some embodiments described herein pertain to quantum systems and devices for generating, preparing, and controlling quantum states for quantum computing (QC) or any other application that may exploit a quantum behavior of waves or matter. In particular, certain embodiments disclosed herein pertain to methods and systems for generating continuous-variable (CV) cluster quantum states, herein referred to as cluster states, usable for one-way quantum computing. Advantageously the disclosed apparatus and methods may provide several advantages, including, but not limited to one or more of the following:
Scalability of the system: the relatively simple structure of the quantum apparatus, small number of components used in the apparatus, tolerance to small deviation from optimal conditions, and simplicity of control mechanisms makes the disclosed apparatus highly scalable, especially using integrated optics. The system may also be modular, and several copies of the apparatus may be used to generate even larger number of qumodes and entangle them together to generate large and versatile cluster states.
Scalability of the cluster state: the disclosed method and quantum apparatus may generate cluster states that include billions of entangled qumodes (each equivalent to one qubit) using a single apparatus and combining spectral and temporal qumode degrees of freedom. The number of qumodes in such cluster states may not have a significant impact on susceptibility of the corresponding cluster state to decoherence and related problems.
Generation of hypercubic cluster states: the disclosed method and quantum apparatus can generate clusters with dimensions ranging from one to larger than three. Notably, a single apparatus may be reconfigured to generate cluster states with an arbitrary dimension without significant impact on the complexity of the system.
Reduced cost and complexity: the disclosed method and the corresponding system designs enable reducing the total number of components and devices required for generating cluster states and the cost associated with the components and fabrication of the corresponding quantum apparatus. For example, a single internally modulated Optical Parametric Oscillator may generate very large cluster state, and the whole can be implemented in integrated optics.
Reconfigurability: the disclosed method and quantum apparatus enable tailoring certain properties of a cluster state generated by the quantum by adjusting the apparatus and without adding new components or subsystem.
Single step quantum clustering: the clustering process used in the disclosed methods and the corresponding systems or apparatus, is not a bottom-up process. The clustering process is performed as a single step in a single device of the system or apparatus. In some cases, all the entanglements required for generating a cluster state from smaller individual entangled states occur simultaneously. As a result, the CV quantum cluster state may be prepared faster. Moreover, the level of immunity of the single step clustering process to noise and decoherence may be higher than that of the conventional systems that use sequential and multi-step clustering processes using a plurality of devices and components.

In some embodiments, a CV quantum cluster state (a cluster state) may be generated by entangling a plurality of independent entangled CV quantum states. In some cases, the plurality of independent entangled CV quantum state may be simultaneously entangled to each other in a single step.

Advantageously various embodiments disclosed herein provide an apparatus for generating a CV cluster quantum state without using optical delays and multiple interferometric measurements in spatial domain.

Certain embodiments disclosed herein provide a scalable method for generating a continuous-variable (CV) cluster quantum state without sequentially entangling a plurality of independent entangled quantum states.

Each of the entangled quantum states may comprise one or more CV quantum states of one or more qumodes that are quantum mechanically entangled. In implementations, a qumode is a non-classical state. For example, a qumode can be a squeezed optical field or a squeezed resonant optical field. In some examples, the clustering process may entangle each state of an independent entangled state with two other states each belonging to a different independent entangled state. In some other embodiments, a cluster state may be generated by entangling a plurality of independent non-classical CV quantum states via a clustering process.

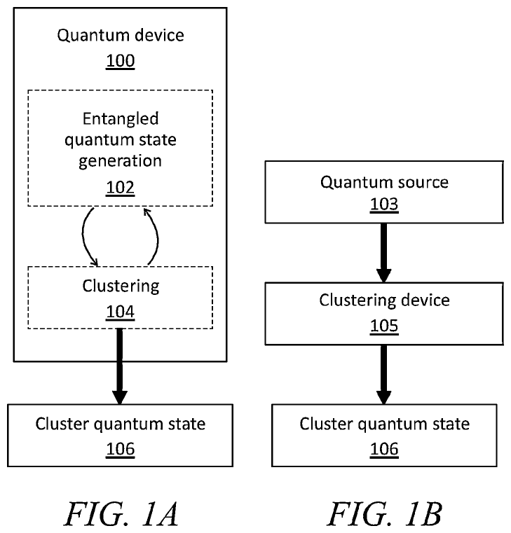

FIG. 1A shows a first example system for generating a cluster quantum state 106. In this example an entangled quantum state generation process 102 and the clustering process 104 may be coupled and performed within a single quantum device 100 (e.g., an optical parametric oscillator). In some cases, the entangled quantum state generation process may be a process for generating a plurality of independent entangled CV quantum states, herein referred to as entangled states, and the clustering process may be a process for entangling the plurality of independent CV quantum states. FIG. 1B shows a second example system for generating a cluster quantum state 106. The second example system may comprise two individual devices unidirectionally coupled to each other. In this example, a quantum source 103 may generate the entangled quantum states independent of the clustering process. The clustering process may be performed by a clustering device 105 that receives the entangled quantum states from the quantum source 103 and generates the cluster quantum state 106. In some cases, the quantum source 103 may generate entangled CV quantum states, and the clustering device may be a device configured to entangle a plurality of CV quantum states. In some embodiments, the entangled quantum states generated by the entangled quantum state generation process 102 or the quantum source 103 are bipartite entangled quantum states where each bipartite entangled quantum state is an entangled CV quantum state comprising two entangled quantum fields. In some cases, the bipartite entangled quantum states are EPR pairs. In some embodiments, the entangled quantum state generation process 102 may be replaced by a non-classical quantum state generation process. In some embodiments, the quantum source 103 may be a source of independent non-classical quantum states and the clustering device 105 may entangle the independent non-classical quantum states.

In some cases, the clustering process in the quantum device 100 or the clustering device 105 may be a single step process through which the plurality of independent CV quantum states are simultaneously entangled to each other. For example, a portion of the independent CV quantum states may be simultaneously entangled to another portion of the independent CV quantum states.

In some embodiments, a CV cluster state, herein referred to as cluster state, can be generated by entangling a plurality of two-qumode entangled states where each qumode is an optical field (e.g., a quantum optical field) associated with a resonant optical field. The two-qumode entangled state can be a two-mode-squeezed state. In some cases, each qumode may comprise an optical field associated with a resonant mode of an optical cavity, herein referred to as a cavity mode, having a distinct frequency, polarization, wave vector, and transverse profile. The qumodes may be generated via a nonlinear optical interaction of a pump field with a nonlinear optical medium and sustained by the optical cavity. The optical cavity is configured to support and sustain a plurality of cavity modes each having a mode frequency, polarization, and transverse field distribution. The resonant frequencies of different cavity modes may be equally spaced with a frequency spacing equal to a free-spectral-range (FSR) of the optical cavity. The optical cavity may be further configured to preserve the quantum properties of resonant optical fields and therefore support generation of qumodes. For example, various losses associated with the optical cavity or the components within the optical cavity may be lower than threshold loss levels. Each qumode may behave as a quantum harmonic oscillator, and a two-qumode entangled state may exhibit properties and behaviors similar to that of two entangled quantum harmonic oscillators, where measuring a physical property in a first quantum harmonic oscillator affects the quantum state of the second quantum harmonic oscillator. Quantum information can be encoded in the quadrature field variables of optical fields, which are analogs of position and momentum for a mechanical oscillator.

In some embodiments, the plurality of the two-qumode entangled states may be entangled to each other to form the cluster state using optical phase modulation. In these embodiments, modulating a phase of the optical field associated with each qumode at one or more modulation frequencies may entangle each qumode of each two-qumode entangled state with qumodes in other two-qumode entangled states and cause the generation of the cluster state. In some cases, the phases of the optical fields associated with all qumodes in an optical cavity of a quantum apparatus may be modulated simultaneously, resulting in simultaneous entanglement of all qumodes. For example, all qumodes may simultaneously become entangled such that a qumode becomes entangles to at least two other qumodes that were not entangled to the qumode. In some examples, each modulation frequency is an integral multiple of the FSR of the optical cavity that sustains the optical fields associated with the two-qumode entangled states.

In some embodiments, the cluster quantum state 106 may comprise two or more cluster quantum states.

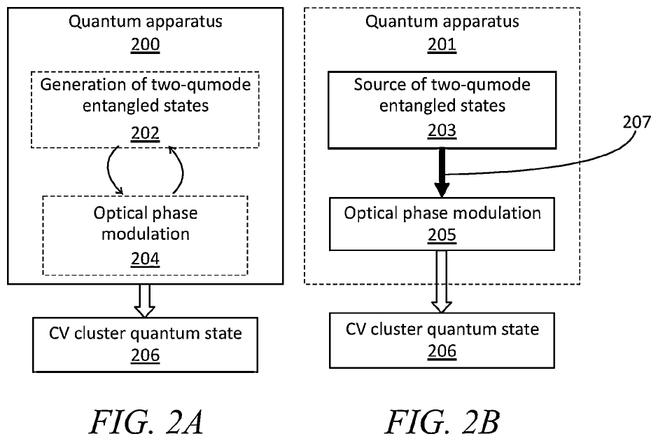

FIGS. 2A and 2B illustrate two examples of quantum apparatus for generating a CV cluster quantum state 206, comprising of a plurality of entangled qumodes using two-qumode entangled states where each qumode is an optical field (e.g., a resonant optical field).

In the quantum apparatus 200 shown in FIG. 2A the generation of two-qumode entangled states 202 and optical phase modulation 204 may occur within the optical cavity that sustains the corresponding qumodes. In some examples, the generation of two-qumode entangled states 202 and optical phase modulation 204 may occur within a single component or two independent components. The optical phase modulation 204 may comprise modulating the phase of the optical field associated with the corresponding qumodes at one or more modulation frequencies, using one or more modulating signals.

The quantum apparatus 201 shown in FIG. 2B comprises a source of two-qumode entangled states 203 and an external optical phase modulator 205. The source 203 may comprise the optical cavity that sustains the qumodes. The optical phase modulator 205 may be configured to receive the two-qumode entangled states 207 generated by the source 203 and modulate the phase of the optical field associated with the corresponding qumodes at one or more modulation frequencies, using one or more modulating signals.

The one or more modulation frequencies may be substantially equal to one or more frequencies of the one or more modulating signals. The one or more modulation frequencies may each be an integral multiple of the FSR of the optical cavity that sustains the optical fields associated with the two-qumode entangled states. In some embodiments, the one or more modulating signals may comprise one or more RF modulating signals. The one or more RF modulating signals can be RF signals generated by one or more RF sources (e.g., RF signal generators). In some other embodiments, the one or more modulating signals may comprise one or more optical modulating signals. The one or more optical modulating signals can be optical waves generated by one or more optical sources (e.g., one or more laser oscillators).

In some embodiments, the quantum apparatus 200 or 201, may be configured to simultaneously generate two or more CV cluster quantum states. In some such embodiments, the CV cluster quantum state 206 may comprise two or more CV cluster quantum states.

Various properties of the cluster quantum state 206 (e.g., topological dimension, entanglement between qumodes, number of qumodes in the cluster, and the like) may be determined by the properties of the two-qumode entangled states and the characteristics of the optical phase modulation (e.g., modulation index, modulation amplitude, number of modulation frequencies, and the like). The characteristics of the optical phase modulation can be controlled, at least partially, by the properties of one or more modulating signals (e.g., RF modulating signals or optical modulating signals) that cause the optical phase modulation. For example, certain properties of the cluster state 206 may be determined by a relative phase or a relative amplitude between two or more RF modulating signals used to drive the optical phase modulator 205 or cause the optical phase modulation 204.

In some cases, the cluster state 206 may be an n-dimensional cluster state where a dimension (n) of the cluster state 206 is an integer (e.g., 1, 2, 3, . . . ) and denotes the topological dimension of the space in which the graph representing the cluster state can be embedded. In these examples, the dimension of the cluster quantum state may be determined by the number of different modulation frequencies at which the phase of the optical fields associated with the qumodes, are modulated. For example, driving the optical phase modulator 205 or performing the optical phase modulation 204 by only one RF modulating signal with a frequency f₁=m₁×FSR, where m₁ is an integer, may result in a one-dimensional cluster quantum state. As another example, driving the optical phase modulator 205 or performing the optical phase modulation 204 by two RF modulating signals with a frequency f₁=m₁×FSR and f₂=m₂×FSR, where m₁ and m₂ are unequal integers, may result in generation of a two-dimensional cluster state. In some cases, a single RF modulating signal is provided to the optical phase modulator 205, or the single RF modulating signal causes the optical phase modulation 204. The single RF modulating signal may comprise two or more modulation frequencies associated with two or more RF field components. In some such cases, relative phases and amplitudes of the RF field components may be determined by an RF modulation format of the single RF modulating signal. In some cases, one or more optical modulating signals may be configured to cause optical phase modulation 204 in the quantum apparatus 200 or drive the optical phase modulator 205 in the quantum apparatus 201 at one or more modulation frequencies.

In some cases, the complexity of the cluster quantum state 206 may be determined by a modulation index of the optical phase modulation. For example, the number qumodes entangled to each qumode may be controlled by the modulation index. In some examples, the modulation index may quantify a strength or level of optical phase modulation.

In some cases, a size of the cluster state 206 (e.g., number of qumodes in the cluster state) may be determined by a number of two-qumodes generated by quantum apparatus. For example, the size of the cluster state 206 may be controlled by number two-qumodes generated by the source 203 and modulated by the optical phase modulators 205.

In some embodiments, the quantum apparatus 201 may generate an optical output field comprising an optical frequency comb (OFC). The qumodes may be associated with optical field components of the OFC or with linear combinations thereof. The optical field components of the OFC may comprise plurality of optical field components oscillating within narrow frequency bands around equally spaced center frequencies. The frequency spacing between the center frequencies may be substantially equal to the FSR of the optical cavity that generates and sustains the OFC. In some cases, an OFC can be a quantum OFC (Q-OFC) where each optical field component of the OFC resembles a quantum harmonic oscillator. For example, a number of photons associated with a harmonic optical field component of the Q-OFC may exhibit a quantum behavior when measured using a photon counting device (e.g., a single photon detector). In some cases, the output optical field of the source 203 may be a Q-OFC comprising optical field components that are entangled in pairs. In some such cases, the CV cluster quantum state 206 may comprise entangled optical fields where each optical field is associated with an optical field component of the Q-OFC.

In some embodiments, the CV cluster quantum state 206 generated by the quantum apparatus 200 may comprise entangled optical fields where each optical field is associated with an optical field component of a Q-OFC generated within an optical cavity of the quantum apparatus 200.

In some embodiments, an OFC or a Q-OFC can be generated using an optical parametric oscillator (OPO). An OPO comprises of three essential elements. An optical cavity that sustains a plurality of cavity modes and a nonlinear optical medium positioned and configured to interact with the plurality of cavity modes or a subset of the cavity modes (e.g., the nonlinear optical medium can be placed in the optical cavity). The OPO further comprises a pump source that generates a pump wave. The pump wave generates a pump field inside the nonlinear optical medium and causes the generation of the OFC via one or more nonlinear optical interactions of the pump field with the nonlinear optical medium. The pump field may be a monochromatic optical field having a pump frequency ωₚ.

In some cases, where the OPO operates based on a second order optical nonlinearity, the nonlinear optical interaction may result in generation of a number of down converted optical field components having frequencies lower than the pump frequency.

In some other cases, where the OPO operates based on a third order optical nonlinearity, the nonlinear optical interaction may result in result in generation of a number of red-shifted optical field components having frequencies lower than the pump frequency, and a number of blue-shifted having frequencies higher than the pump frequency.

In some examples, the number of red-shifted optical field components maybe substantially equal to the number of blue-shifted optical field components. Each of the downconverted, red-shifted or blue-shifted optical field components may be associated with a qumode. The frequencies of the downconverted, blues-shifted or red-shifted optical field components (qumodes) are substantially equal to the frequencies of the cavity modes.

In some embodiments, an OPO can be configured to generate a Q-OFC that comprises a plurality of two-qumode entangled states. In some examples, the two-qumode entangled states may be two-squeezed states. In some such embodiments, an optical phase of each qumode of each two-qumode entangled state may be modulated to generate a cluster state. In some examples, the cluster may be generated by modulating the phase of an output optical field coupled out of the OPO, at one or more modulation frequencies. In some other examples, the cluster state may be generated by modulating the phase of the internal optical field of the OPO at one or more modulation frequencies. The one or more modulation frequencies may be integral multiples of the FSR of the optical cavity of the OPO. In some embodiments, an optical power of the pump wave that drives the OPO may be selected to maintain the operation of the OPO below a threshold operation.

In some embodiments, the quantum apparatus 200 is an internally modulated OPO. In some embodiments, the source of two-qumode entangled states 203 may be quantum apparatus 201 is an OPO.

In some embodiments, the OPO can be a non-degenerate OPO (e.g., an OPO generated using a non-degenerate nonlinear optical process).

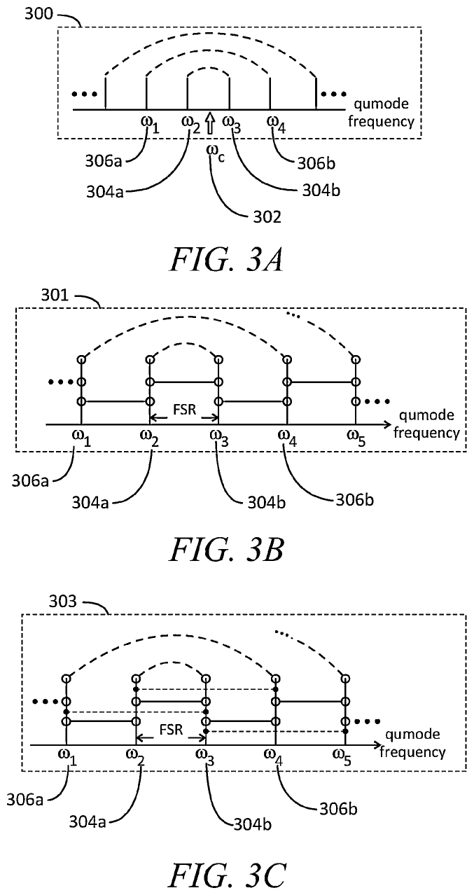

FIG. 3A illustrates a frequency spectrum 300 of a Q-OFC comprising two-qumode entangled states (e.g., generated by an OPO), showing relative spectral positions of several optical field components of the OPO, corresponding to the qumodes, with respect to a center frequency 302. As shown in FIG. 3A a portion of the optical field components are red-shitted with respect to the center frequency (ω_{c}) 302 and another portion the optical field components are blue-shitted with respect to the center frequency (ω_{c}) 302. In some cases, the number of red-shifted field components is equal to the number of blue-shifted frequency components. In some cases, where the optical field components are generated via a second-order nonlinear optical interaction, the center frequency (ω_{c}) 302 is half of the pump frequency (ωₚ/2) and the field components are generated by down conversion of the pump. In some other cases, where the optical field components are generated via a third order nonlinear optical interaction, the center frequency (ω_{c}) 302 is equal to the pump frequency (ωₚ). In various embodiments, a Q-OFC (e.g., having the frequency spectrum 300) may be generated via a nonlinear optical interaction when the pump frequency (ωₚ) or half of the pump frequency (ωₚ/2) is substantially equal to the frequency of a qumode. Curved dashed lines depict the entangled qumode pairs. For example, the qumode associated with the red-shifted frequency ω₂ 304a is entangled with the qumode associated with the blue-shifted frequency ω₃ 304b, and the qumode associated with the red-shifted frequency ω₁ 306a is entangled with the qumode associated with the blue-shifted frequency ω₄ 306b.

FIG. 3B illustrates a frequency spectrum 301 of a Q-OFC comprising a one-dimensional cluster state generated by modulating the phase of the optical field components of the Q-OFC 300 at a first modulation frequency of f₁=FSR. Each solid straight line in FIG. 3B depicts entanglement between two qumodes represented by two optical field components, in the frequency spectrum 301, that are connected by the solid straight line. The curved dashed lines depict the two-qumode entangled states of the Q-OFC 300 used to generate the one-dimensional cluster state. The optical phase modulation at f₁=FSR generates the one-dimensional cluster state by entangling each qumode with two nearest neighbor qumodes having frequencies lower and higher than the qumode by one FSR. For example, optical phase modulation at f₁=FSR causes the qumode associated with the red-shifted frequency ω₂ 304a that belongs to a first two-qumode entangled state, to become entangled to the qumode associated with the red-shifted frequency ω₁ 304b that belongs to a second two-qumode entangled state.

FIG. 3C illustrates a frequency spectrum 303 of a Q-OFC comprising a two-dimensional cluster state generated by modulating the phase of the optical field components of the Q-OFC 300 at a first modulation frequency of f₁=FSR and a second modulation frequency of f₂=2×FSR. Each solid straight line in FIG. 3C depicts entanglement between a qumode and its nearest neighbors represented by two optical field components, in the frequency spectrum 303. Each dashed straight line in FIG. 3C depicts entanglement between a qumode and its second nearest neighbors represented by two optical field components with a frequency spacing of 2×FSR, in the frequency spectrum 303. In general, adding a second modulation frequency f₂=n×f₁ will result in a square-lattice graph state of width n, as specified in the next section.

In some embodiments, the optical phase modulation at f₁=FSR and f₂=2×FSR generates the two-dimensional cluster state shown in FIG. 3C by entangling each qumode with two nearest neighbor qumodes, having frequencies lower and higher than the qumode by one FSR, and with two second nearest neighbors having frequencies lower and higher than the qumode by 2×FSR. For example, optical phase modulation at a second modulation at f₂=2×FSR causes the qumode associated with the frequency ω₂ 304a that belongs to a first two-qumode entangled state and is entangled to the qumode associated with the frequency ω₁ 304b by the first modulation frequency f₁=FSR, to further become entangled to the qumode associated with the frequency ω₃ 306b. In these embodiments, a magnitude of the modulation index associated with each modulation frequency (f₁ or f₂) is selected such that phase modulation at each frequency entangles a qumode with no more than two qumodes. In other words, the modulation index is small enough to prevent generation of more than two frequency side bands upon modulating the phase of the corresponding optical field.

A cluster state can be represented using a graph where the qumodes are represented by the nodes (vertices) and the entanglement between the qumodes are represented by edges that connect the nodes. A cluster state that comprises a plurality of two-qumode entangled states (e.g., EPR qumode pairs) entangled together (e.g., the cluster states shown in FIG. 3B and FIG. 3C) may be represented by a graph where each node (vertex) represents a two-qumode entangled state. In this case, the nodes may be referred to as “macronodes” or “EPR macronodes”. A graph uniquely represents a cluster state. The graph can be used to capture and quantify characteristics of a cluster state. For example, the number of edges connected to each macronode in the graph represent the number of neighboring EPR qumode pairs that are entangled to the EPR qumode pair represented by the macronode. The relation between controllable parameters of the quantum apparatus (e.g., quantum apparatus 200 or 201 in FIG. 2) that generates the cluster state 206 and the characteristic of the cluster state may be described using the graph that represents the cluster state 206.

In some embodiments, certain properties of a cluster state generated by the quantum apparatus 200 or 201 can be determined by an operator of the quantum apparatus using one or more control parameters whose value can be changed or selected by the operator. The one or more control parameters may be associated with one or more components or devices included in the quantum apparatus. For example, the control parameter can be the frequency of one of the RF modulating signals used for optical phase modulation, the phase of one of the RF modulating signals used for optical phase modulation, a number of RF modulating signals having different RF frequencies used for optical phase modulation, the amplitude of each of the one or more RF modulating signals used for optical phase modulation, the output power of a pump source used to generate the two-qumode entangled states. In some embodiments, the certain properties of the cluster state that are determined by a control parameter may be associated with topological properties of a corresponding graph. In some such examples, the one or more control parameters may be used to determine the properties of the corresponding graph. Since the characteristics of a cluster state are uniquely represented by a graph representing the cluster state, the utility of the cluster state as resource for quantum computation (e.g., one wat QC) may be determined by the characteristics of the graph (e.g., its topological properties). As such, the control parameters described above may be used to tailor a cluster state such that it can serve as an entangled resource state for a specific QC task.

For example, as described above, the dimension of a cluster state generated using a Q-OFC comprising EPR qumode pairs (two-qumode entangled states) and optical phase modulation, is determined by the number of modulation frequencies used to modulate the phase of the EPR qumode pairs. Accordingly, the dimension of a graph that represents such cluster state is determined by the number of modulation frequencies used to modulate the phase of the EPR qumode pairs. In some cases, the number of macronodes in a graph represent the total number of EPR qumode pairs in the cluster and, therefore, the size of the cluster state.

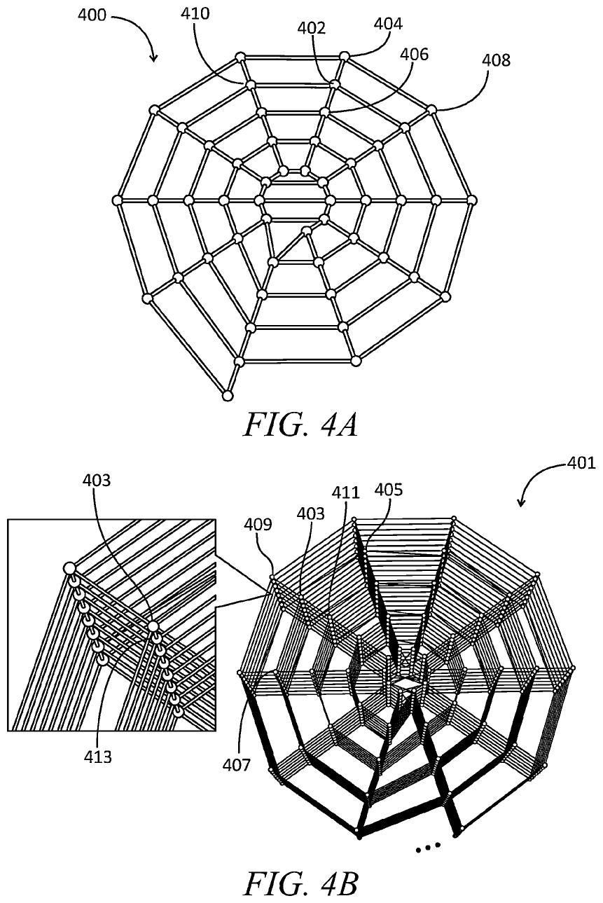

FIG. 4A is graph 400 representing a square grid cluster (a type of two-dimensional cluster) state comprising 50 EPR macronodes generated by modulating an optical phase of the qumodes of two-qumode entangled states associated with a Q-OFC, at f₁=1×FSR and f₂=10×FSR. The number of spokes in a graph, that represents a square grid cluster, is determined by a ratio between the two modulation frequencies used to generate the square grid cluster state. For example, the graph 400 shown in FIG. 4A has 10 spokes (lines that are radially extended from the center of the graph toward the edge of the graph) corresponding to f₂/f₁=10. The number of macronodes along a spoke can be determined by dividing the total number of macronodes by the number of spokes. As such, the number macronodes, the number of spokes and the number of macronodes along each spoke in a 2D graph associated with a 2D cluster state can be controlled by the number and a relative magnitude of modulation frequencies used to generate the 2D cluster state.

FIG. 4B is graph state 401 comprising 400 EPR macronodes representing a cubic cluster state (a type of three-dimensional cluster state) generated by modulating an optical phase of the qumodes of two-qumode entangled states associated with a Q-OFC, at f₁=FSR, f₂=8 FSR and f₃=80 FSR. The number of spokes in graph 401, that represents a cubic cluster is determined by a ratio between two modulation frequencies used to generate the cluster state 401 (e.g., the ratio between the largest modulation frequency and the second largest modulation frequency). For example, the graph 401 shown in FIG. 4A has 10 spokes (lines that are radially extended from the center of the graph toward the edge of the graph) corresponding to f₃/f₂=10. Additionally, the number of layers in a three-dimensional cluster state may be determined by the ratio between the second largest frequency and the smallest modulation frequency). For example, the graph 401 shown in FIG. 4A has 8 layers corresponding to f₂/f₁=8.

The mathematical framework that may be used to calculate the properties of the cluster state is disclosed in the publication (referenced herein as the “Mathematical framework”), the entire contents of which is incorporated by reference herein and made a part of this specification.

### Example Quantum Apparatus

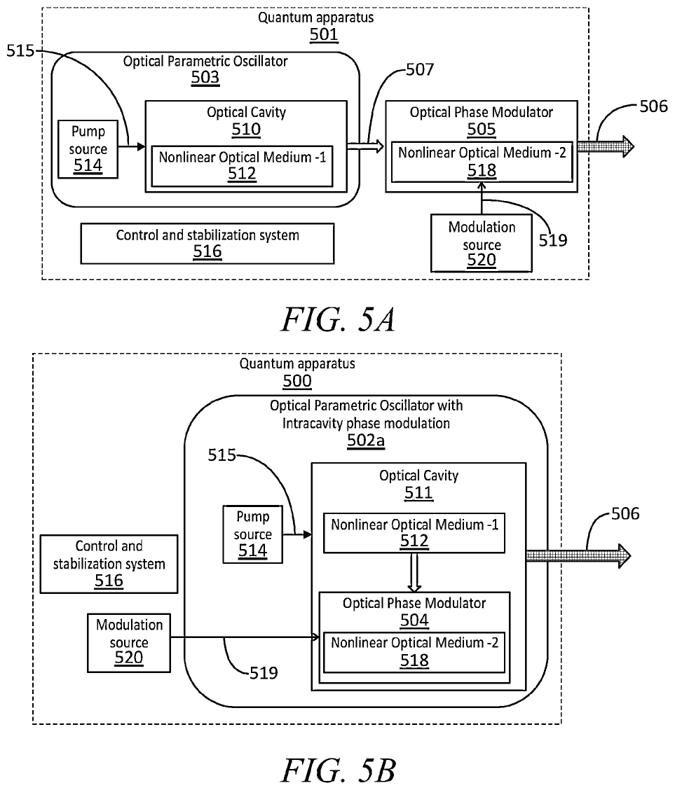

In some embodiments, the quantum apparatus 201 may use an optical parametric oscillator (OPO) as the source of two-qumode entangled states. FIG. 5A shows an example of such quantum apparatus 501 comprising an OPO 503 an optical phase modulator 505 a modulation source 520 and a control and stabilization system 516. The OPO 503 generate an OPO output 207 that may comprise an optical frequency comb (OFC) and transmits the OPO output 207 to the optical phase modulator 505 driven by the modulation source 520. The optical phase modulator 505 may use the OPO output 207 and one or more modulating signals 519 generated by the modulation source 520, to generate an output 506 as the output of the quantum apparatus 501. In some cases, the output 506 can be a cluster state.

In some embodiments, OPO 503 may comprise an optical cavity 510, a first nonlinear optical medium 512 and a pump source 514. The optical cavity 510 may support a plurality of cavity modes each having a resonant frequency where the resonant frequencies are equally spaced with a frequency spacing equal to a free-spectral-range (FSR) of the optical cavity. The first nonlinear optical medium 512 and the optical cavity 510 may be configured to enable an interaction (e.g., a nonlinear optical interaction) between the first nonlinear optical medium 512 and the resonant optical fields associated the plurality of cavity modes. The resonant frequencies and the FSR of the optical cavity 510 may be determined, based at least in part, by one or more resonant optical path lengths inside the optical cavity 510 and therefore by a configuration of the optical cavity (e.g., a geometry of the cavity, a size of the cavity, an arrangement of cavity components and/or sections and the like), properties of the optical cavity components or sections (e.g., optical properties, shape, size, and the like) and properties of the first nonlinear optical medium (e.g., optical properties of the corresponding material, size, geometry and the like).

The pump source 514 may be a single frequency optical source (e.g., a laser) that generates a pump wave 515 having a pump frequency, cop, and transmits the pump wave to the first nonlinear optical medium via a pump port of the optical cavity 510. A polarization and a direction of propagation of the pump wave 515, inside the first nonlinear optical medium 512 may be selected based on a phase-matching or quasi-phase-matching condition. In some examples, the pump wave 515 may be linearly polarized. In some other examples, the pump wave 515 may be circularly or elliptically polarized. The pump source 514 can be an optical source, for example, a single mode laser (e.g., a semiconductor laser, a solid-state laser, a fiber laser and the like). In some embodiments the pump source 514 may be a tunable optical source (e.g., a tunable laser) whose frequency/wavelength can be tuned, for example, by a user of the quantum apparatus 501, the control and stabilization system 516 or and external controller. A first nonlinear optical interaction between the pump wave 515 and the first nonlinear optical medium 512 may generate the optical frequency comb (OFC) comprising a plurality of resonant optical fields (or resonant optical field components) having frequencies equal to the resonant frequencies of the cavity modes.

The OFC may be generated and amplified via the first nonlinear optical interaction and sustained by the optical cavity 510. The first nonlinear optical medium 512 may be configured to support generation and amplification of the OFC under a phase-matching condition or a quasi-phase-matching condition. In some embodiments, the first nonlinear optical interaction may be a non-degenerate optical interaction.

The pump wave may have a pump power (e.g., electromagnetic power transmitted by the pump wave) between 0.1 mW and 10 mW, 10 mW and 1 W, 1 W and 10 W, or 10 W and 100 W. In some embodiments, an optical power of the pump wave may be selected to maintain the operation of the OPO below a threshold operation. The pump wave may be an optical wave comprising optical pump fields oscillating at frequencies distributed (e.g., according to a Lorentzian distribution function) within a narrow bandwidth around the pump frequency, ωₚ. The pump frequency can be between 10 THz to 500 THz, 500 THz to 1000 THz, 1000 THz to 5000 THz, or 5000 THz to 10000 THz. The bandwidth of the pump wave may be smaller than the FSR of the corresponding cavity (e.g., by a factor of 100, 1000, or larger). In some examples, the FSR of the cavity can be between 1 GHz and 10 GHz, 10 GHz and 50 GHz, 50 GHz and 100 GHz, 100 GHz and 1 THz. In some such examples, the bandwidth of the pump wave may be between 1 KHz and 100 KHz, 100 KHz and 1 MHz, or 1 MHz and 1 GHz.

In some embodiments, where the OPO operates based on a second order nonlinearity, half of the pump frequency (ωₚ/2) may be substantially equal to the sum of the resonant frequencies of two consecutive cavity modes. In some such embodiments, the pump field may generate down converted optical fields comprising a red-shifted field oscillating at a frequency ω_{d}=ωₚ/2−FSR/2 and a blue-shifted field oscillating at a frequencies ωᵤ=ωₚ/2+FSR/2 where ω_{d} and ωᵤ are substantially equal to resonant frequencies of two consecutive cavity modes (e.g., with reference to FIG. 3A, cod may be equal to ω₂ and ωᵤ may be equal to ω₃).

In some embodiments, where the OPO operates based on a third order nonlinearity, the pump frequency (ωₚ) may be substantially equal to the sum of the resonant frequencies of two consecutive cavity modes. In some such embodiments, the pump field may generate optical fields comprising a red-shifted field oscillating at a frequency ω_{d}=ωₚ−FSR/2 and a blue-shifted field oscillating at a frequencies ωᵤ=ωₚ+FSR/2 where cod and ωᵤ are substantially equal to resonant frequencies of two consecutive cavity modes (e.g., with reference to FIG. 3A, cod may be equal to ω₂ and ωᵤ may be equal to ω₃).

The first nonlinear optical interaction may be a second order or a third order nonlinear optical interaction. In some cases, generation of the OFC using the third order nonlinear optical interaction may allow the first nonlinear optical medium to be composed of materials that are compatible with conventional optical integration and monolithic fabrication method (e.g., silicon). Advantageously, using such materials as the first non-linear optical medium may enable integration of the quantum apparatus 500, completely or partially on a chip.

In some embodiments, the pump source 514 may comprise two or more optical sources (e.g., two or more lasers) that generate two or more pump waves having different pump frequencies and different pump powers. Advantageously, using two or more pump waves may provide additional control over the type and properties of the resonant optical fields and corresponding qumodes. In some embodiments, using two or more pump waves may enable simultaneous generation of two or more clusters. For example, two pump waves having two different polarizations may simultaneously generate two different clusters. In some such embodiments, a control over the frequency and or power of the two or more pump waves may be used to independently control each cluster of a plurality of clusters.

In some embodiments, the OPO is a quantum OPO that generates a quantum OFC (Q-OFC) where the plurality of resonant optical fields are in non-classical states of light. For example, the plurality of resonant optical fields may comprise a plurality of qumodes that exhibit certain quantum (non-classical) behaviors upon a measurement. In some such embodiments, the optical cavity 510, the pump source 514, the nonlinear optical medium 512 and the control and stabilization system 516 may be configured to generate and sustain resonant optical fields being in non-classical states of light. For example, the plurality of qumodes may be in squeezed states also referred to as squeezed qumodes. In some embodiments, the plurality of qumodes may comprise a plurality of entangled qumode pairs in two-mode qumode entangled states where each two-qumode entangled state comprises a first qumode having a frequency ω_{d,m}=ωₚ/2−(M+½)×FSR and a second qumode having a frequency ω_{u,m}=ωₚ/2+(M+½)×FSR where M is an integer. In some such embodiments, the plurality of qumodes may comprise a plurality of entangled squeezed qumode pairs (e.g., two-mode-squeezed states). The total number of qumodes or two-qumode entangled states in a Q-OFC may be determined based at least in part by the properties of the pump wave (e.g., frequency, intensity, polarization, direction of propagation, and the like), the properties of the first nonlinear optical medium 512, the properties of the optical cavity 510 and a phase-matching condition or a quasi-phase-matching condition for generation of the Q-OFC. For example, the total number of qumodes (or a number of optical field components) in a Q-OFC may be determined by a phase matching bandwidth within which a phase matching condition or a quasi-phase matching condition is satisfied. In some cases, a level of stability of the Q-OFC (e.g., small operating fluctuations of all outputs and the corresponding parameters) may allow temporal multiplexing of outputs generated at different times and therefore increasing the number of qumodes or two-qumode entangled states by way of sequential processing.

In some embodiments, a portion of the resonant optical fields associated with the OFC or Q-OFC may be coupled out of the optical cavity 510 via the OPO output port, as the OPO output 507, and transmitted to an optical phase modulator 505. In some such embodiments, a portion of the resonant optical fields associated the Q-OFC may comprise a portion of each qumode associated with the Q-OFC. The optical phase modulator 505 may use the one or more modulating signals 519 (e.g., RF modulating signals or optical modulating signals) to modulate an optical phase of the portion of each qumode transmitted from the OPO output port (e.g., the portion of the resonant optical fields associated with the OFC that is coupled out of the optical cavity 510), at one or more modulation frequencies to generate the output 506. In some embodiments, the second nonlinear optical medium 518 is configured to interact with the optical output 507 and the one or more modulating signals 519 received from the modulation source 520, to modulate the optical phases of the corresponding qumodes (e.g., resonant optical fields) at one or more modulation frequencies. In some embodiments, the optical phase modulator 505 may modulate the optical phase of the portion of each qumode transmitted from the OPO output port with a modulation index, m. In some examples, the modulation index may be controlled by the one or more modulating signals 519 (e.g., by amplitudes if the one or more modulating signals). In some examples, the modulation source 520 may be controlled by a user, the control and stabilization system 516, or an external controller to select or control the modulation index. In some cases, modulation index can be between 0.001 and 0.01, 0.01 and 0.1, 0.1 and 0.2, 0.2 and 0.3, 0.3 and 0.4 or other numbers.

In some cases, the modulation source may be configured to generate one or more modulating signals having one of more modulating frequencies that are integral multiples of the FSR. In some such cases, the output 506 may comprise a cluster state. A size of the cluster state may be substantially equal to the number of qumodes whose optical phases are modulated by the optical phase modulator 505. In some embodiments, the output 506 may comprise two or more cluster states.

In some embodiments, modulating the optical phase of a qumode, transmitted from the OPO output port, entangles the qumode to a number of qumodes belonging to other two-qumode states. In some such embodiments, the modulation index, m, may control the number of qumodes to which the qumode becomes entangled. As such, the modulation index may be used as a control parameter to control a topology of the cluster state 506. For example, when modulation frequency is equal to FSR, the qumode may be entangled to neighboring qumodes (in frequency domain) where neighboring qumodes comprise qumodes having frequencies that are larger or smaller than a frequency of the qumode by one or more FSRs. In some embodiments, the modulation index, m, may be selected such that the qumode is only entangled to a pair of neighboring qumodes having frequencies that are larger or smaller that the frequency of the qumode by one FSR. Advantageously, such modulation index may result in generation of a cluster state that is more useful for certain quantum computing applications.

In some embodiments, the optical phase modulator 505 is an electro-optic phase modulator, the modulation source 520 is an RF modulation source and the one or more modulating signals 519 are RF modulating signals. In these embodiments, the optical phase modulator 505 may comprise one or more electrodes configured to support one or more RF fields inside the second nonlinear optical medium 518, and one or more RF ports to receive the one or more RF modulating signals. The RF ports are electrically coupled to the one or more RF electrodes. The electro-optic phase modulator may be configured to enable the second nonlinear optical interaction (e.g., corresponding to a linear electro-optic effect) between the one or more RF fields and the OPO output 507 received from the OPO 503, inside the second nonlinear optical medium 518. The one or more RF fields may be generated by one or more RF modulating signals 519 received by the one or more RF ports. The one or more RF modulating signals may be generated by an RF modulation source 520 and may have one or more RF frequencies. In some examples, each of the one or more RF modulating signals may be a sinusoidal RF signal having a single RF frequency. In some examples, each RF signal may comprise two or more RF frequencies. The second nonlinear optical interaction inside the second nonlinear medium 518 may modulate optical phases of the optical fields associated with the OPO output 507 at the one or more RF frequencies. In some examples, a relative RF phase between each pair of the one or more RF modulating signals 519 may be a constant RF phase. In some cases, the relative RF phase may be controlled by the modulation source 520. In some such cases, where the output 506 is a cluster state, certain properties of the cluster state may be determined by the relative RF phase. In some examples, a relative RF amplitude between each pair of the one or more RF modulating signals 519 may be a constant. In some cases, the relative RF amplitude may be controlled by the modulation source 520. In some such cases, where the output 506 is a cluster state, certain properties of the cluster state may be determined by the relative RF amplitude.

In some embodiments, the optical phase modulator 505 may be an all-optical phase modulator, the modulation source 520 may be an optical source and the one or more modulating signals 519 can be one or more optical modulating signals. In these embodiments, the optical phase modulator 505 may comprise one or more optical modulation input ports configured to receive the one or more optical modulating signals. The all-optical optical phase modulator may be configured to enable a third nonlinear optical interaction (e.g., corresponding to a third order nonlinear optical effect) between the one or more optical modulating signals received from the modulation source 520, inside the second nonlinear optical medium 518. For example, the one or more optical modulating signals may modulate the phases of the qumodes associated with the OPO output 507 via cross-phase modulation. Advantageously, employing an all-optical phase modulator may enable higher modulation frequencies. Since the FSR of the optical cavity is inversely proportional to the one or more resonant optical path lengths inside the cavity 510, higher modulation frequencies may allow reducing a size of the optical cavity 510 and still generate of cluster states (e.g., by selecting the one or more modulation frequencies to be equal to in integral multiple of the FSR). In some embodiments, the high modulation frequencies enabled by the all-optical phase modulator may allow reducing a size of the optical cavity and reducing an overall size of the quantum apparatus 501. In some such embodiments, at least the optical cavity 510 and the first nonlinear optical medium 512 can be fabricated on a single chip.

In some embodiments, the first nonlinear optical medium 512 may comprise a first optical material and the second optical medium 518 may comprise a second nonlinear optical material. In some cases, a strength of the first or second nonlinear optical interactions may be proportional to a magnitude of a second order nonlinear optical parameter (or coefficient) or a third order nonlinear optical parameter (or coefficient) for the first or second nonlinear optical material. In some embodiments, the second order nonlinear optical parameter may be larger than the third order nonlinear optical parameter. In some other embodiments, the third order nonlinear optical parameter may be larger than the second order nonlinear optical parameter of those materials. In yet other embodiments, the first nonlinear optical material may have a third order nonlinear optical parameter larger than the second order nonlinear parameter and the second nonlinear optical material may have a second order nonlinear optical parameter larger than the third order nonlinear parameter.

The first and second optical nonlinear material may include, lithium niobate, lithium tantalite, KDP, KTP, silicon, silica, silicon nitride, IIIV semiconductor material (e.g., GaAs, GaAlAs, InP, and the like).

The control and stabilization system 516 may automatically control the pump source 514 and/or the optical cavity 510 to control the generation and to stabilize a parameter associated with the qumodes or resonant optical fields inside the optical cavity 510, OPO output 507, and the output 506. The control parameters may include amplitude, phase, photon flux, frequency, intensity, polarization, power and the like. For example, the control and stabilization system 516 may actively maintain a frequency difference between the pump frequency and the resonant frequency of a cavity mode. In some embodiments, the control and stabilization system may comprise one or more optical and/or electronic devices or subsystems such as mirrors, lenses, optical RF filters, polarization controllers, beam splitters, attenuators, photodetectors, Pound-Drever-Hall (PDH) lock loops, phase-lock loops, servo-loop filters (e.g., analog, or digital filters) and the like. In some embodiments, the control and stabilization system 516 may comprise a memory configured to store data and machine-readable instructions and a processor configured to execute the machine-readable instructions to control one or more devices, components or parameters of the quantum apparatus 200. In some embodiments, the control and stabilization system 516 may be implemented using any combination of one or more of: software, firmware, or hardware components. For example, and without limitation, illustrative types of hardware components that may be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), Graphics Processing Units (GPUs), Central Processing Units (CPUs), or any other type of hardware processor.

In some embodiments, the control and stabilization system 516 may control the optical phase modulator 505 and the RF modulation source 520 to control the generation and characteristics of the output 506. In some cases, where the OPO output 507 comprises a plurality of two-qumode entangled states and the output comprises a cluster state, the control and stabilization system 516 may allow adjusting one or more characteristics of the cluster state and maintaining a value of each characteristic at or near a desired value. In some embodiments, the control and stabilization system 516 may support both autonomous control and user control. For example, a user may select the number RF modulating signals provided to the optical phase modulator, a frequency of each RF signal or an amplitude of each RF signal, while the generation and characteristic of the two-qumode entangled states are automatically stabilized. It will be understood that enabling control over certain properties of the cluster state is an important feature that distinguishes the disclosed quantum apparatus and the corresponding methods, from existing source of cluster states. In some cases, the control systems used to generate, stabilize and control the properties of a cluster state can also mesh with or be integrated with processing controls that govern subsequent quantum computing carried over the cluster state. For example, one or more processors of a computing system may simultaneously control the generation of a cluster state and perform quantum computing operations using the cluster state.

In some embodiments, the quantum apparatus 200 may comprise an optical parametric oscillator (OPO) with intracavity phase modulation that generates an output comprising a phase modulated OFC or a phase modulated Q-OFC. FIG. 5B shows an example of such quantum apparatus 500 that comprises an OPO 502a with intracavity phase modulation 502a, a control and stabilization system 516 and an RF modulation source 520. The quantum apparatus 500 shown in FIG. 5B may comprise one or more of the embodiments described with respect to quantum apparatus 501 in FIG. 5A. In some cases, the output 506 of the quantum apparatus 500 can be a cluster state. In some other cases, the output 506 may comprise two or more cluster states.

In some embodiments, the OPO with intracavity phase modulation 502 comprises an optical cavity 511, a first nonlinear optical medium 512, an optical phase modulator 504, and a pump source 514. The optical cavity 511 may support a plurality of cavity modes. In some embodiments, at least a portion of the first nonlinear optical medium 512 and/or a section of the optical phase modulator 504 may be located inside the optical cavity 511. The optical phase modulator 504 may comprise a second nonlinear optical medium 518. The optical phase modulator 504 may include one or more embodiments of the electro-optic modulator or the all-optical phase modulator described with respect to optical phase modulator 505 in quantum apparatus 501 (FIG. 5A). The optical phase modulator 504, the first nonlinear optical medium 512 and/or the optical cavity 511, may be configured to enable simultaneous interaction among the resonant optical fields associated the plurality cavity modes, the first nonlinear optical medium 512 and the second nonlinear optical medium 518. Each of the plurality of cavity modes has a resonant frequency and the resonant frequencies are equally spaced with a frequency spacing equal to a free-spectral-range (FSR) of the optical cavity. The resonant frequencies and the FSR of the optical cavity 511 may be determined, based at least in part, by one or more resonant optical path lengths inside the optical cavity 511 and therefore by a configuration of the optical cavity 511 (e.g., geometry and size), properties of one or more optical cavity components, properties of the first nonlinear optical medium 512 and the properties of the second 518 nonlinear optical medium 518 (e.g., optical properties of the corresponding material, size, geometry and the like).

In some embodiments, the optical pump source 514 generates an optical pump wave 515 and transmits the optical pump wave 515 to the first nonlinear optical medium 512 where a first nonlinear optical interaction between the pump wave 515 and the nonlinear optical medium 512 inside the optical cavity 511, generates the optical frequency comb (OFC) comprising a plurality of resonant optical fields having frequencies equal to the resonant frequencies of the cavity modes. Each resonant optical field may oscillate at a frequency associated with a resonant frequency of a cavity mode of the plurality of cavity modes.

In some embodiments, the OFC may be a quantum OFC (Q-OFC) where the plurality of resonant optical fields are qumodes that comprise nonclassical states of light and/or exhibit certain quantum behaviors upon a measurement. For example, the qumodes may comprise squeezed resonant optical fields. The Q-OFC may be amplified by the first nonlinear optical interaction and sustained by the optical cavity 510. The first nonlinear optical medium 512 may be configured to support generation and amplification of the Q-OFC under a phase-matching condition or a quasi-phase-matching condition. The optical phase modulator 504 may be configured to receive one or more modulating signals 519 (e.g., RF modulating signals or optical modulating signals) and modulate optical phases of the plurality of qumodes (resonant optical fields) at one or more modulation frequencies, as they are generated and amplified within the optical cavity 511.

In some embodiments, the plurality of qumodes may comprise a plurality of two-mode qumode entangled states where each two-qumode entangled state comprises a first qumode having a frequency ω_{d,m}=ωₚ/2−(M+½)×FSR and a second qumode having a frequency ω_{u,m}=ωₚ/2+(M+½)×FSR where M is an integer. Total number of two-qumode entangled states in a Q-OFC may be determined based at least in part by the properties of the pump wave 515 (e.g., frequency, intensity, power, direction of propagation with respect to a crystal axis, and the like), the properties of the first nonlinear optical medium 512, the properties of the optical cavity 210 and a phase-matching condition or a quasi-phase-matching condition for generation of the Q-OFC. In some embodiments, when the modulating optical phase modulator 504 receives the one or more modulating signals 519 from a modulation source 520, each qumode in each of the plurality of the entangled qumode pairs may become entangled with two or more qumodes each belonging or a different qumode pair and form a cluster state within the optical cavity 511. In these embodiments, a portion of the resonant optical fields associated with the cluster state formed inside the optical cavity 511 may be coupled out of the optical cavity 511 as the output 506 of the quantum apparatus 200.

In some embodiments, the pump source 514 may provide two or more pump waves to the optical cavity 510. In some such examples, the additional pump waves may enable additional control over the characteristic of the resulting cluster state. In some other embodiments the additional pump waves may enable simultaneous generation two or more cluster states.

In some embodiments, the OPO with intracavity phase modulation 502 may comprise an optical cavity 511, the first nonlinear optical medium 512, and a pump source 514. In these embodiments, the first nonlinear optical medium 512 may be configured to generate the OFC or the Q-OFC and modulate the optical phase of the qumodes associated with the OFC or the Q-OFC, using one or more modulating signals 519 received from the modulation source 520. In some such embodiments, the generation and optical phase modulation of the qumodes may occur inside two separate regions of the first nonlinear optical medium 512. In some other embodiments, the generation and optical phase modulation of the qumodes may occur simultaneously inside a single region of the first nonlinear optical medium 512. In some cases, two or more conducting electrodes may be provided on a region of the first nonlinear optical medium 512. These electrodes may be configured to support one or more RF fields inside the first nonlinear optical medium 512.

The disclosed quantum apparatus architectures (e.g., FIG. 5A and FIG. 5B) are example implementations for the general quantum apparatus, described with respect to FIG. 2A and FIG. 2B, for generating cluster states (e.g., CV quantum cluster states). In some embodiments, these architectures may be implemented based on free-space optical components. In some embodiments, these architectures may be implemented using fiber-optic optical devices/components (e.g., fiber pigtailed optical devices and components). In some embodiments, these architectures may be implemented, based on hybrid and/or monolithic integration using variety of optical components adapted to such integration methods. Such on-chip implementation may significantly reduce the cost, complexity and the size the quantum apparatus. In various embodiments, these architectures may be implemented using a combination of free-space optical devices/components, fiber-optic optical devices/components and on-chip devices/components. In some examples, one or more devices or sub-systems may be implemented on a chip while other components and modules of the system may be fabricated based on free-space and/or fiber-optic components. In general, any combination of on-chip (e.g., monolithic, hybrid integration and the like), free-space and fiber-optic devices may be used to implement any of the architectures disclosed and described herein.

In some examples, the pump source 514 can be on-chip or off-chip laser source. In some examples, the pump source 514 can be a fiber-coupled device coupled to the optical cavity via an optical fiber. In some examples, the pump 514 source can be a coupled to the cavity via one or more free-space optical components. In some examples, the pump source 514 can be a coupled to an on-chip optical cavity using a vertical grating coupler, similar to vertical grating couplers known to those skilled in the art. In some examples, one or more off-chip optical components (e.g., lenses, lensed fibers and the like) may be used to enhance the efficiency of the optical coupling between the fiber coupled photon source and the waveguide.

The optical cavity 510 or 511 can be free-space optical cavity comprising two or more mirrors. For example, the optical cavity 510 or 511 can be a Fabry-Perot optical cavity, a ring cavity, or a closed optical path that can support and sustain resonant optical modes. In some examples, the optical cavity may be an on-chip optical cavity monolithically fabricated on a substrate. The on-chip optical cavity can be a Fabry-Perot cavity formed between two reflectors (e.g., two waveguide Bragg reflectors, two coated facets, and the like), a ring resonator (e.g., a closed waveguide loop having a circular, racetrack or other shapes), a photonic crystal cavity, or any structure that can support or sustain resonant optical mode confined within a waveguide layer or structure. In some embodiments, the first nonlinear optical medium may be integrated with the on-chip optical cavity. In some other examples, the first nonlinear optical medium may a region or a portion of the optical cavity structure. For example, a portion of an integrated optical cavity may be fabricated or formed using a material that supports the first nonlinear optical interaction.

In some embodiments, the optical phase modulator 504 or 505 can be free-space or fiber pigtailed modulator. In some other embodiments, the optical phase modulator 504 or 505 can be integrated optical phase modulators. In some such embodiments, phase modulator 504 or 505 can be integrated with optical cavity 510 or 511 on a single chip.

The RF modulation source can be an external RF source comprising of one or more RF oscillators. In some embodiments, the RF oscillators may be mutually phased locked RF oscillators configured to generate one or RF signals each having an RF frequency. Each RF frequency can be from 1 MHz to 1 GHz, from 1 GHz to 10 GHz, from 10 GHz to 50 GHz, from 50 GHz to 100 GHz, or within a range bounded by one or more of the foregoing values. In some embodiments, the RF modulation may be configured to maintain a relative phase and/or a relative amplitude of each pair of the one or more RF signals constant. In some such embodiments, the relative phase and/or the relative amplitude may be adjustable by a user. In some embodiments, in addition to the one or more RF oscillators, the RF modulation source may comprise one or more RF components configured to combined RF output signals (e.g., sinusoidal signals) generated by each of the one or more RF oscillators to generate the one or more RF signals. For example, one or more RF mixers may be used to generate one or more RF signals each comprising of a modulated RF signal (e.g., amplitude modulated or phase modulated) having a RF modulation format. In these examples, the RF source may be configured to allow the user to select or adjust the RF modulation format.

In some embodiments, the optical cavity 510 and the first nonlinear optical medium 512, are fabricated on a chip while the pump source 514, the optical phase modulator 505, the second nonlinear optical medium 518 the control and stabilization system 516 and the modulation source 520 are off-chip devices.

In some embodiments, the optical cavity 510 and the first nonlinear optical medium 512, the optical phase modulator 505, and the second nonlinear optical medium-2 are fabricated on a chip while the pump source 514, the control and stabilization system 516 and the modulation source 520 are off-chip devices.

In some embodiments, the optical cavity 511, the first nonlinear optical medium 512, the optical phase modulator 504 and the second nonlinear optical medium 518, are fabricated on a chip while the pump source 514, the optical phase modulator 505, the control and stabilization system 516 and the modulation source 520 are off-chip devices.

The on-chip devices and components of the quantum apparatus 200 or the quantum apparatus 201 can be implemented based on variety of optical configurations and using variety of optical materials (e.g., silicon, silica, silicon nitride, lithium niobate, III-V material and the like).

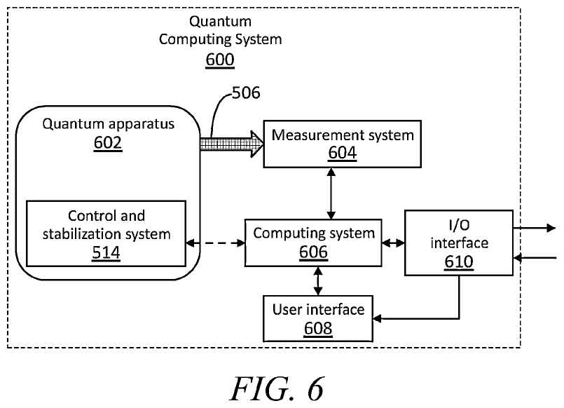

FIG. 6 shows a block diagram of an example quantum computing system 600 for one-way QC. In some embodiments, the quantum computing system 600 may comprise a quantum apparatus 602 for generating and controlling a cluster state 506 (a CV quantum cluster), a measurements system 604 configured to encode and processing quantum information by performing measurements and feedforwarding on the cluster state 506, a computing system 606 configured to control the operation of the measurement system 604, a user interface 608, and an input/output (I/O) interface 610. In some cases, the computing system may also control the generation and properties of the cluster state 506.

In at least some aspects, the quantum apparatus 602 may be similar to or the same as the quantum apparatus 500 or 501 described above. The quantum apparatus 602 may include the control and stabilization system 514 configured to stabilize the cluster state 506 and control a parameter of the cluster state 506. In some cases, the control and stabilization system 514 may control the cluster state 506 based at least in part on the signals and/or data received from the computing system 606.

In some embodiments, the computing system may comprise at least a processor (e.g., an electronic processor) and a storage device (e.g., an electronic memory). The processor may control the operation of the measurement system 604 by executing machine-readable instructions stored in the storage device and the instructions and/or data received from the user interface 608 and/or from the I/O interface 610.

The user interface 608 may be configured to generate data and instructions usable for controlling the operation of the measurement system 604 based on a user interaction with the user interface 608. Further, the user interface 608 may be configured to display the measurement or computational outcomes to the user.

In some examples the I/O interface 610 may be configured to transmit and/or receive data/instructions to/from another computing system (e.g., a computing network, a cloud computing system, a computing system of another quantum computing system, a classical computer, and the like). The I/O interface 610 may be in communication (e.g., wired or wireless communication) with the other computing system.

In some embodiments, a quantum algorithm may be implemented using the quantum computing system by the following steps:

1) The quantum apparatus 602 generates a cluster state 506 (e.g., using one of the methods described above with respect to quantum apparatus 200/201 or 500/501). The properties of the cluster 506 state may be controlled and/or selected by the control and stabilization system 514. In some cases, the properties of the cluster 506 may be controlled at least in part by the computing system 606 via the control and stabilization system 514.

2) The computing system 606 may select one or more measurement bases based on the quantum algorithm and/or the data/instructions stored in a memory of the computing system 606, received from the user interface 608, or the I/O interface 610.

3) The measurement system 604 may perform one or more measurements on the cluster state 506 received from the quantum apparatus 602 using the measurement bases selected by the computing system 606. The measurement may comprise a sequence of local (single qubit) measurements based on the selected measurement. Further, the measurement system 604 may perform other operations on the cluster state that may result in feedforwarding to qubits adjacent to a qubit on which a measurement is performed. In some examples, feed forwarding may include changing the amplitude or shifting the qubit.

4) The computing system 606 may receive the outcome of the measurements and feedforwarding procedures and transmit the corresponding data to the user interface 608 and/or the I/O interface 610. In some cases, the outcome may be a quantum state of the cluster state resulting from the measurements and feed forwarding operations performed on the cluster. In some such cases, the computing system may use the outcome to generate results associated with a solution of a problem solved by the quantum algorithm.

### Terminology

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes one or more computers or processors. The code modules may be stored in any type of non-transitory computer-readable medium or other computer storage device. Some or all the methods may be embodied in specialized computer hardware. Further, the computing system may include, be implemented as part of, or communicate with, a computation network or a cloud computing system.

Many other variations than those described herein will be apparent from this disclosure. For example, depending on the embodiment, certain acts, events, or functions of any of the algorithms described herein can be performed in a different sequence, can be added, merged, or left out altogether (for example, not all described acts or events are necessary for the practice of the algorithms). Moreover, in certain embodiments, acts or events can be performed concurrently, for example, through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, for example, a combination of a DSP and a microprocessor, a plurality of microprocessors, one or more microprocessors in conjunction with a DSP core, or any other such configuration. Although described herein primarily with respect to digital technology, a processor may also include primarily analog components. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (for example, X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

Many variations and modifications may be made to the above-described embodiments, the elements of which are to be understood as being among other acceptable examples. All such modifications and variations are intended to be included herein within the scope of this disclosure.

1. An apparatus generating a cluster quantum state using bipartite entangled states, the apparatus comprising:
an optical parametric oscillator (OPO) configured to generate a plurality of two-qumode entangled states, the OPO comprising:
an optical cavity having a free-spectral-range and configured to sustain a plurality of qumodes;
a first nonlinear optical medium located inside the optical cavity and configured to interact with the plurality of qumodes;
an optical source configured to generate a pump wave having a pump frequency (ωₚ) and transmit the pump wave into the first nonlinear optical medium to generate the plurality of qumodes via a first nonlinear optical interaction of the pump wave with the first nonlinear optical medium, wherein the plurality of qumodes comprises at least two successive qumodes in frequency domain, wherein a frequency spacing between the two successive qumodes is equal to the free-spectral range, and wherein the plurality of qumodes comprise the plurality of two-qumode entangled states; and
an OPO output port configured to transmit a portion of optical fields associated with the plurality qumodes out of the optical cavity; and
an optical phase modulator configured to generate the cluster quantum state by modulating a phase of the portion of the optical fields associated with the plurality of qumodes transmitted from the OPO output port at one or more modulation frequencies and with a modulation index, wherein the one or more modulation frequencies are integral multiples of the free-spectral-range.

2. The apparatus of claim 0, wherein the cluster quantum state is generated by simultaneously entangling at least a portion of the plurality of qumodes via optical phase modulation.

3. The apparatus of claim 0, wherein the optical phase modulator comprises:
an input optical port configured to receive the portion of the optical fields associated with the plurality of qumodes;
a second nonlinear optical medium configured to interact with the portion of the optical fields received from the input optical port;
one or more RF ports configured to receive one or more RF signals and generate RF fields inside the second nonlinear optical medium to modulate the phase of the optical fields via a second nonlinear optical interaction; and
an optical output port configured to transmit output optical fields comprising the cluster quantum state.

4. The apparatus of claim 0, further comprising one or more RF sources configured to generate the one or more RF signals, wherein the one or more RF signals have one or more RF frequencies, and wherein each RF frequency is equal to the one or more modulation frequencies.

5. The apparatus of claim 0, wherein the optical phase modulator comprises:
an input optical port configured to receive the portion of the optical fields associated with the plurality of qumodes;
a second nonlinear optical medium configured to interact with the portion of the optical fields received from the input optical port; and
one or more optical modulation ports configured to receive one or more optical modulating signals wherein the one or more modulating optical signals are configured to modulate the phase of the optical fields at one or more modulation frequencies via a second nonlinear optical interaction between the optical fields and the one or more optical signals inside the second nonlinear medium.

6. The apparatus of claim 0, further comprising one or more optical sources configured to generate the one or more optical signals.

7. The apparatus of claim 1, wherein the plurality of qumodes comprise a plurality of resonant optical fields inside the optical cavity.

8. The apparatus of claim 1, wherein the optical phase modulator generates the cluster quantum state by entangling at least one qumode in at least one two-qumode entangled state to a number of qumodes in other two-qumode entangled states, wherein the number of qumodes in other two-qumode entangled states is determined by the modulation index.

9. The apparatus of claim 0, wherein the modulation index is sufficiently small so that the optical phase modulator entangles a qumode with two qumodes.

10. The apparatus of claim 0, wherein the plurality of qumodes comprises a plurality of non-classical optical fields, and wherein the plurality of non-classical optical fields comprises squeezed states.

11. The apparatus of claim 0, wherein at least some of the plurality of two-qumode entangled states comprise a two-squeezed Einstein-Podolski-Rosen (EPR) pair.

12. The apparatus of claim 0, wherein the modulation index is greater than 0 and less than 1.

13. The apparatus of claim 1, wherein a dimension of the cluster quantum state is equal to a number of modulation frequencies.

14. The apparatus of claim 0, wherein a size of the cluster quantum state is equal to a number of qumodes.

15. The apparatus of claim 1, wherein the first nonlinear optical interaction is a second order nonlinear optical interaction.

16. (canceled)

17. The apparatus of claim 1, wherein the first nonlinear optical interaction is a third order nonlinear optical interaction.

18-20. (canceled)

21. The apparatus of claim 5, wherein the second nonlinear optical interaction is a third order nonlinear optical interaction.

22-27. (canceled)

28. The apparatus of claim 4, further comprising a control and stabilization system configured to control a property of the cluster quantum state at least partially by controlling the one or more RF signals.

29-32. (canceled)

33. An apparatus for generating a cluster quantum state using bipartite entangled states, the apparatus comprising:
an optical cavity having a free-spectral-range and configured to sustain a plurality of qumodes;
a first nonlinear optical medium located inside the optical cavity and configured to interact with the plurality of qumodes;
an optical source configured to generate a pump wave having a pump frequency (ωₚ) and transmit the pump wave into the first nonlinear optical medium to cause the generation of the plurality of qumodes via a first nonlinear optical interaction of the pump wave with the first nonlinear optical medium, wherein the plurality of qumodes comprises at least two successive qumodes in frequency domain, wherein a frequency spacing between two successive qumodes is equal to the free-spectral range and the plurality of qumodes comprise a plurality of two-qumode entangled states; and
an optical phase modulator located inside the optical cavity and configured to generate the cluster quantum state by modulating a phase of the optical fields associated with the plurality of the qumodes at one or more modulation frequencies and with a modulation index, wherein each of the one or more modulation frequencies is equal to an integral multiple of the free-spectral-range.

34. The apparatus of claim 33, wherein the cluster quantum state is generated by simultaneously entangling at least a portion of the plurality of qumodes via optical phase modulation.

35. The apparatus of claim 33, wherein the optical phase modulator comprises:
a second nonlinear optical medium configured to interact with the plurality of qumodes; and
one or more RF ports configured to receive one or more RF signals and generate RF fields inside the second nonlinear optical medium to modulate the phase of optical fields associated with the plurality of the qumodes.

36. The apparatus of claim 35, further comprising one or more RF sources configured to generate the one or more RF signals, wherein the one or more RF signals have one or more RF frequencies, and wherein each RF frequency is equal to the one or more modulation frequencies.

37-93. (canceled)
